(19) United States
(12) Patent Application Publication
(10) Pub. No.: US 2024/0069163 A1
(43) Pub. Date: Feb. 29, 2024

(54) SENSOR BARRIER STRUCTURE AND ENVIRONMENTAL SENSOR INCLUDING THE SAME

(71) Applicants: HYUNDAI MOTOR COMPANY, Seoul (KR); KIA CORPORATION, Seoul (KR)

(72) Inventor: Young Dug Yang, Seoul (KR)

(73) Assignees: HYUNDAI MOTOR COMPANY, Seoul (KR); KIA CORPORATION, Seoul (KR)

(21) Appl. No.: 18/086,870

(22) Filed: Dec. 22, 2022

(30) Foreign Application Priority Data
Aug. 29, 2022 (KR) 10-2022-0108050

(51) Int. Cl. G01S 7/481; G01S 17/88

(52) U.S. Cl. CPC G01S 7/4813; G01S 17/88

(57) ABSTRACT

A sensor barrier structure includes an intake portion provided in an environmental sensor installed in a vehicle. In particular, the environmental sensor includes a sensing portion configured to detect surrounding environment of the vehicle and a passage of fluid flow is formed from the intake portion to the sensing portion in the environmental sensor.

### CROSS-REFERENCE TO RELATED APPLICATION

This application claims, under 35 U.S.C. § 119(a), the benefit of and priority to Korean Patent Application No. 10-2022-0108050, filed on Aug. 29, 2022, the entire contents of which are incorporated herein by reference.

### BACKGROUND

### (a) Field

The present disclosure relates to a sensor barrier structure of a vehicle, and more particularly, to a barrier structure capable of protecting sensors in operation.

### (b) Background Art

Recently, a driver assistance system that assists a driver of a vehicle is mounted in a vehicle in order to secure safe traveling in various traveling situations. In addition to the driver assistance system, research and development on a self-driving vehicle capable of driving itself without driver intervention has been actively conducted.

For such a driver assistance system, various types of environmental sensors capable of sensing surrounding environment in various ways are mounted in a self-driving vehicle. Environmental sensors installed in a vehicle may be a radar, a LiDAR, a camera, and the like.

Because these sensors are mounted on the outer side of the vehicle, the sensing regions thereof may easily become dirty due to foreign substances, such as dust, rain, snow, or the like. Therefore, in order to maintain the performance of the sensors, these sensors must be kept clean at or above a predetermined level. For this reason, a contamination detection device configured to detect contamination on these sensors and a sensor cleaning system capable of cleaning the sensors when the sensing region is detected to be contaminated are provided in the vehicle.

The above information disclosed in this Background section is provided only to enhance understanding of the background of the present disclosure, and therefore it may contain information that does not form the prior art that is already known to a person of ordinary skill in the art.

### SUMMARY OF THE DISCLOSURE

The present disclosure has been made in an effort to solve the above-described problems associated with the prior art, and it is an object of the present disclosure to provide a sensor barrier structure capable of significantly lowering the contamination level of a sensor during traveling of a vehicle.

Another object of the present disclosure to provide a sensor barrier structure capable of minimizing the operation of a sensor cleaning system of a vehicle using a compressor, etc.

The objects of the present disclosure are not limited to the above-mentioned objects, and other objects not mentioned should be clearly understood by those of ordinary skill in the art to which the present disclosure pertains (hereinafter, “those skilled in the art”) based on the description below.

In one aspect of the present disclosure, a sensor barrier structure includes an intake portion provided in an environmental sensor installed in a vehicle. In particular, the environmental sensor may include a sensing portion configured to detect surrounding environment of the vehicle and have an inner portion having formed therein a fluid passage from the intake portion to the sensing portion.

In one embodiment, an environmental sensor may be disposed in a vehicle and configured to sense the surrounding environment. The environmental sensor may include a fluid passage configured to receive a traveling wind of the vehicle so as to form a flow passage of the traveling wind, and the fluid passage may receive the traveling wind to form an air curtain at the environmental sensor.

Other aspects and embodiments of the present disclosure are discussed below.

It should be understood that the terms “vehicle” or “vehicular” or other similar terms as used herein include motor vehicles in general. Such motor vehicles may encompass passenger automobiles including sport utility vehicles (SUVs), buses, trucks, various commercial vehicles, watercraft including a variety of boats and ships, aircraft, and the like. The passenger automobiles include hybrid vehicles, electric vehicles, plug-in hybrid electric vehicles, hydrogen-powered vehicles, and other alternative fuel vehicles (e.g. fuels derived from resources other than petroleum). As referred to herein, a hybrid vehicle is a vehicle that has two or more sources of power, for example, a vehicle powered by both gasoline and electricity.

The above and other features of the present disclosure are discussed below.

### BRIEF DESCRIPTION OF THE DRAWINGS

The above and other features of the present disclosure are now described in detail with reference to certain exemplary embodiments thereof illustrated in the accompanying drawings which are given hereinbelow by way of illustration only, and thus are not limitative of the present disclosure, and wherein:

FIG. 1 illustrates a sensor cleaning system of a vehicle;

FIG. 2 illustrates a passage through which compressed air is supplied to clean sensors on a vehicle;

FIG. 3 is a front view of a lidar sensor including a sensor barrier structure according to one embodiment of the present disclosure;

FIG. 4 is a perspective view of a lidar sensor including a sensor barrier structure according to one embodiment of the present disclosure;

FIG. 5 is a perspective view of a lidar sensor including a sensor barrier structure, showing a cross-section taken along line A-A of FIG. 4, according to one embodiment of the present disclosure;

FIG. 6 is a transmissive view illustrating the inside of an upper cap of a lidar sensor including a sensor barrier structure according to one embodiment of the present disclosure; and

FIG. 7 shows a state in which an upper cap of a lidar sensor including a sensor barrier structure is removed according to one embodiment of the present disclosure.

It should be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes, should be determined in part by the particular intended application and usage environment.

In the figures, the reference numbers refer to the same or equivalent parts of the present disclosure throughout the several figures of the drawing.

### DETAILED DESCRIPTION

Descriptions of specific structures or functions presented in the embodiments of the present disclosure are merely exemplary for the purpose of explaining the embodiments according to the concept of the present disclosure, and the embodiments according to the concept of the present disclosure may be implemented in various forms. In addition, the descriptions should not be construed as being limited to the embodiments described herein, and should be understood to include all modifications, equivalents and substitutes falling within the idea and scope of the present disclosure.

Meanwhile, in the present disclosure, terms such as “first” and/or “second” may be used to describe various components, but the components are not limited by the terms. These terms are only used to distinguish one component from another. For example, a first component could be termed a second component, and similarly, a second component could be termed a first component, without departing from the scope of exemplary embodiments of the present disclosure.

It should be understood that when a component is referred to as being “connected to” another component, the component may be directly connected to the other component, or intervening components may also be present. In contrast, when a component is referred to as being “directly connected to” another component, there are no intervening components present. Other terms used to describe relationships between components should be interpreted in a like fashion (e.g., “between” versus “directly between,” “adjacent” versus “directly adjacent,” etc.). When a component, device, element, or the like of the present disclosure is described as having a purpose or performing an operation, function, or the like, the component, device, or element should be considered herein as being “configured to” meet that purpose or to perform that operation or function.

Throughout the specification, like reference numerals indicate like components. The terminology used herein is for the purpose of illustrating embodiments and is not intended to limit the present disclosure. In this specification, the singular form includes the plural sense, unless specified otherwise. The terms “comprises” and/or “comprising” used in this specification mean that the cited component, step, operation, and/or element does not exclude the presence or addition of one or more of other components, steps, operations, and/or elements.

Hereinafter, the present disclosure is described in detail with reference to the accompanying drawings.

As described above, a self-driving vehicle, a vehicle equipped with a driver assistance system, and the like have mounted thereon various types of environmental sensor configured to detect the surrounding environment. As a non-limiting example, the environmental sensor may include a lidar, a radar, a camera, and the like, and may be mounted on the front portion, rear portion, side portion, roof, etc. of a vehicle.

Because a vehicle is mostly outdoors and in motion, environmental sensors mounted on the outer side of the vehicle may be contaminated not only by rain, but also by foreign substances, such as dust and insects. For this reason, a sensor cleaning system is provided in the vehicle to clean the contaminated environmental sensors. Cleaning of the environmental sensors may be performed by using a washer fluid or by spraying high-pressure compressed air.

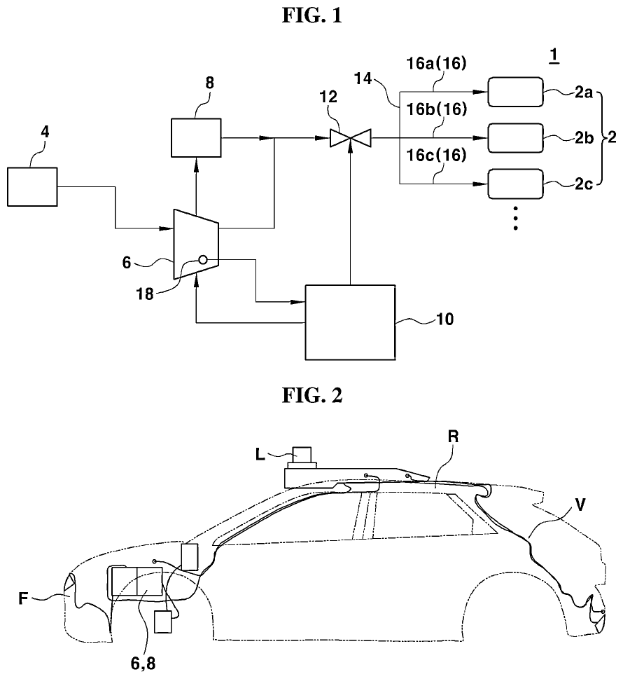

FIG. 1 illustrates an exemplary sensor cleaning system provided in a vehicle. The sensor cleaning system includes an air-cleaning system 1 configured to clean an environmental sensor 2 using compressed air. The air-cleaning system 1 sprays compressed air on the surface of the environmental sensor 2 so as to perform cleaning.

Specifically, air filtered through an air filter 4 provided in the vehicle is introduced into a compressor 6. The air is compressed in the compressor 6 and then sprayed on the surface of the environmental sensor 2 to remove foreign substances on the environmental sensor 2. The environmental sensor 2 includes environmental sensors 2a, 2b, 2c, and may be mounted on the front, rear, roof, sides, etc. of the vehicle. Although there are disclosed three environmental sensors in this specification and the drawings, the number of environmental sensors is not limited thereto and may be increased or decreased.

In addition, the air-cleaning system 1 includes an air tank 8. Air compressed in the compressor 6 or air filling the air tank 8 by an external device may be used for cleaning of the environmental sensors 2.

The air-cleaning system 1 includes a controller 10 configured to operate a valve 12, for example, a solenoid valve, in a predetermined situation such as every preset period or when the environmental sensor 2 detects contamination. Accordingly, the compressed air is sprayed from the compressor 6 or from the air tank 8 to each of the environmental sensor 2, and the environmental sensors 2 are cleaned. Specifically, the valve 12 is provided with a distributor 14 to distribute the compressed air through nozzles 16 (16a, 16b, and 16c) each for a corresponding one of the environmental sensors 2.

The controller 10 may also control the operation of the compressor 6. The controller 10 may control the operation of the compressor 6 so that the compressor 6 operates within a range of an operating limit temperature. To this end, the compressor 6 is provided with a temperature sensing portion 18. The temperature of the compressor 6 sensed by the temperature sensing portion 18 is transmitted to the controller 10 of the air-cleaning system 1. The controller 10 may control the operation of the compressor 6 based on the temperature sensed by the temperature sensing portion 18.

As illustrated in FIG. 2, a lidar sensor L, in particular, among the environmental sensors is installed on a roof R of a vehicle V. Like other environmental sensors, compressed air may be supplied to the lidar sensor L from the compressor 6 or from the air tank 8, which is usually mounted on a front F of the vehicle V. When needed, the controller 10 may perform cleaning by spraying compressed air to the lidar sensor L.

The lidar sensor L has a shape that is open 360 degrees (°), and thus the lidar sensor L is more exposed to polluting environments than other environmental sensors. However, because power consumption is high for regular cleaning, cleaning is performed only when contamination is detected.

Moreover, the front portion of the lidar sensor L is more likely to be contaminated than other portions of the lidar sensor L when traveling. In consideration of this likelihood, when the front portion of the lidar sensor L is protected, the operation of the sensor cleaning system may be reduced, and power consumption may be reduced. For this reason, in the present disclosure, a sensor barrier is formed by traveling wind at the front portion of the lidar sensor L without additional power consumption to minimize contamination of the surface of the sensor. Hereinafter, the lidar sensor is described as an example, but the sensor barrier structure of the present disclosure may be applied not only to the lidar sensor but also to other sensors.

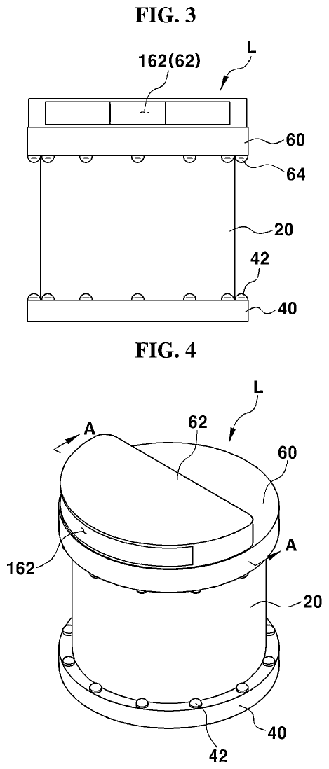

As illustrated in FIGS. 3 and 4, the lidar sensor L is configured to sense the surrounding environment using a sensing portion 20. The sensing portion 20 has a lower cap 40 mounted on one side thereof and has an upper cap 60 mounted on another side thereof. In some embodiments, the lower cap 40 and the upper cap 60 may be provided separately from the sensing portion 20 and assembled to the sensing portion 20. In some embodiments, the lower cap 40 and the upper cap 60 may be integrated with the sensing portion 20, but each may be a term used herein to refer to a corresponding component. In addition, the lower cap 40 and the upper cap 60 may be portions configured to supply compressed air from the air-cleaning system 1 to the sensing portion 20.

The lower cap 40 is disposed on one side of the lidar sensor L. In an embodiment, the lower cap 40 may be a portion disposed on the lower portion of the lidar sensor L and seated on the roof R of the vehicle V. In some embodiments, the lower cap 40 is provided with a plurality of spray holes 42. The spray holes 42 may be spaced apart from each other at certain intervals along the circumference of the lower cap 40 and face the sensing portion 20. Compressed air from the air-cleaning system 1 may be supplied to the spray holes 42 and then be sprayed on the sensing portion 20 through the spray holes 42 to clean the sensing portion 20.

The upper cap 60 is disposed on the opposite side of the lower cap 40 in the lidar sensor L. In other words, the upper cap 60 may be disposed to face the lower cap 40 with the sensing portion 20 positioned therebetween. In an embodiment, the upper cap 60 may be disposed on the upper portion of the lidar sensor L.

The upper cap 60 includes a plurality of holes 64. The holes 64 are arranged to face the sensing portion 20. In some embodiments, the holes 64 may be passages through which compressed air from the air-cleaning system 1 is sprayed on the sensing portion 20. In some embodiments, as described below, the holes 64 may be passages through which air drawn to an intake portion 62 is sprayed. In some embodiments, some holes 64 may function as passages through which compressed air from the air-cleaning system 1 is sprayed, and some holes 64 may function as passages through which air entering the intake portion 62 is sprayed.

The holes 64 may be spaced apart from each other at a certain interval along the circumference of the upper cap 60. In an embodiment, the holes 64 may be disposed at the circumference of the upper cap 60 by being spaced at a predetermined interval.

The intake portion 62 is an opening formed in the upper cap 60 or a structure including an opening. In some embodiments, the intake portion 62 may extend along the circumference of the upper cap 60. When the lidar sensor L is mounted on the vehicle V, the intake portion 62 is disposed to open towards the front of the vehicle V. For example, the intake portion 62 may be opened in a direction substantially facing the direction of the traveling wind of the vehicle V. In other words, FIG. 3 illustrates the lidar sensor L viewed from the front of the vehicle V to the rear.

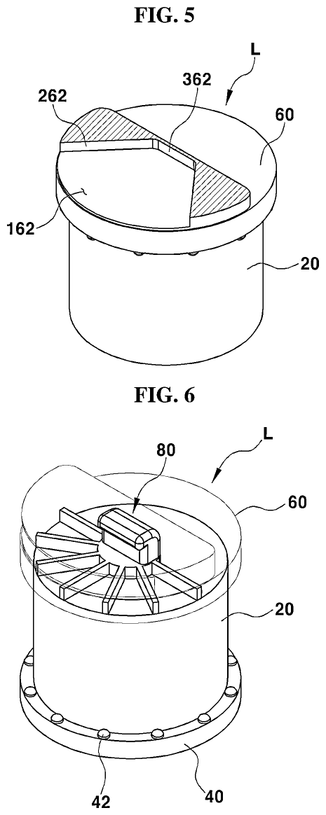

Referring to FIG. 5, the intake portion 62 may include a distal portion 162, an extension 262, and a proximal portion 362. The distal portion 162 may be the edge of the intake portion 62 and is located upstream of the traveling wind flowing towards the lidar sensor L when the vehicle moves forwards. The traveling wind or air introduced into the distal portion 162 moves along the extension 262 in the intake portion 62. From the distal portion 162 to the extension 262, i.e., towards downstream in the direction of the traveling wind, the area of the intake portion 62 becomes smaller. To this end, the extension 262 extends obliquely from the distal portion 162 towards the center of the upper cap 60. The extension 262 extends to the proximal portion 362. Among the distal portion 162, the extension 262, and the proximal portion 362, the proximal portion 362 has the smallest opening area. In addition, the proximal portion 362 may communicate with the interior of the upper cap 60 or with a nozzle assembly 80.

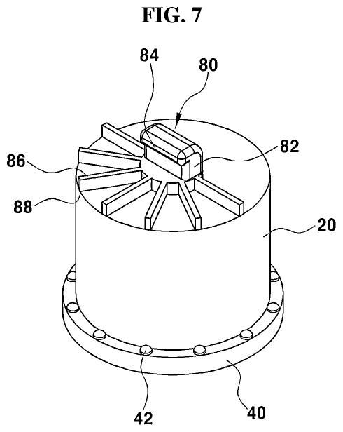

Referring to FIGS. 6 and 7, the nozzle assembly 80 is accommodated in the upper cap 60. In one embodiment, the nozzle assembly 80 includes a main body 82, an inlet 84, and a radial passage 86. An inlet 84 is arranged in the main body 82. The inlet 84 is aligned with the proximal portion 362 to communicate with the intake portion 62 to direct air passing through the proximal portion 362 into the main body 82.

The nozzle assembly 80 includes a plurality of radial passages 86. Each of the radial passages 86 extends radially outwards from the main body 82 of the nozzle assembly 80. In some embodiments, the radial passages 86 may be provided around the entire circumference of the lidar sensor L. In some embodiments, the radial passages 86 may be provided within a predetermined range of the circumference of the lidar sensor L. As illustrated in FIG. 7, the radial passages 86 may be provided only within a range of 180 degrees (°) in the circumferential direction of the lidar sensor L. All the radial passages 86 may be located in a circumferential range within 180° in the lidar sensor L at the front of the vehicle V.

The radial passages 86 may each be provided with a nozzle 88. The nozzle 88 is disposed to be aligned with the hole 64 in the upper cap 60. Accordingly, the traveling wind introduced through the intake portion 62 while the vehicle V is traveling is introduced into the nozzle assembly 80. High-speed air is sprayed on the front surface of the sensing portion 20 through the nozzle 88 to form a sensor barrier like an air curtain.

Hereinafter, the operation of the sensor barrier structure according to the present disclosure is described in detail. The sensor barrier structure according to the present disclosure forms a fluid passage, i.e., a flow path of the traveling wind, from the intake portion 62 to the sensing portion 20. The traveling wind or air flowing when the vehicle V is traveling is introduced into the intake portion 62. The air is first introduced into the lidar sensor L through the distal portion 162 of the intake portion 62 and then flows through the extension 262 to the proximal portion 362.

Air flowing into the proximal portion 362 is introduced into the nozzle assembly 80. Because the proximal portion 362 is aligned to communicate with the inlet 84 of the nozzle assembly 80, the air flows into the main body 82 of the nozzle assembly 80. Thereafter, the air in the main body 82 may flow through the radial passages 86 to be sprayed towards the sensing portion 20 through each nozzle 88, which is an outlet of the traveling wind.

According to the present disclosure, because the opening area or cross-sectional area through which air passes becomes smaller from the intake portion 62 to the distal portion 162, the extension 262, the proximal portion 362, and to the nozzle 88, the speed of the air may be increased. The high-speed air may be sprayed onto the sensing portion 20. Therefore, according to the present disclosure, an air curtain like a barrier may be maintained at all times while traveling. As such, owing to the air curtain formed by the traveling wind, the front surface of the lidar sensor L, which is mainly polluted during vehicle travel, may be kept clean and protected at all times.

According to the present disclosure, because the air curtain is always formed while the vehicle is traveling and prevents contamination of the sensor, the operation of the sensor cleaning system may be minimized, and the power consumption needed in the operation of the sensor cleaning system may be reduced.

The upper cap 60 and the lower cap 40 have been described as being portions separated from the sensing portion 20. As described, the upper cap 60 and the lower cap 40 may be components provided separately on the upper portion and the lower portion of the sensor. The upper cap 60 and the lower cap 40 may also be interpreted as simply indicating the upper and lower portions of the lidar sensor L.

Moreover, although the intake portion 62 has been described herein as being provided in the upper cap 60, the design thereof is not limited thereto. In other words, the intake portion 62 may be provided in the lower cap 40, or may also be provided in both the upper cap 60 and the lower cap 40.

As is apparent from the above description, the present disclosure provides the following effects.

According to the present disclosure, the sensor barrier structure is capable of greatly reducing the degree of contamination of a sensor during vehicle travel.

In addition, according to the present disclosure, the sensor barrier structure can of minimize the operation of a sensor cleaning system of a vehicle using a compressor or the like.

Effects of the present disclosure are not limited to those described above, and other effects not mentioned should be clearly recognized by those having ordinary skill in the art based on the above description.

It should be apparent to those of ordinary skill in the art to which the present disclosure pertains that the present disclosure described above is not limited by the above-described embodiments and the accompanying drawings, and various substitutions, modifications and changes are possible within a range that does not depart from the technical idea of the present disclosure.

What is claimed is:

1. A sensor barrier structure comprising:
an intake portion provided in an environmental sensor installed in a vehicle,
wherein the environmental sensor comprises a sensing portion configured to detect surrounding environment of the vehicle, and a passage of fluid flow is formed from the intake portion to the sensing portion in the environmental sensor.

2. The sensor barrier structure according to claim 1, wherein the passage of fluid flow has a cross-sectional area gradually decreasing from the intake portion to the sensing portion.

3. The sensor barrier structure according to claim 1, wherein the intake portion is disposed to face a front of the vehicle.

4. The sensor barrier structure according to claim 1, wherein the passage of fluid flow comprises:
a distal portion being an inlet for a fluid and provided in the intake portion; and
one or more nozzles being an outlet for the fluid passing through the passage of fluid flow and provided in the environmental sensor,
wherein the nozzle is disposed to face the sensing portion.

5. The sensor barrier structure according to claim 4, wherein the one or more nozzles are spaced apart from each other within a predetermined range in a portion of the environmental sensor facing a front of the vehicle.

6. The sensor barrier structure according to claim 1, wherein the intake portion has a cross-sectional area gradually decreasing towards an inner side of the environmental sensor.

7. The sensor barrier structure according to claim 6, wherein the intake portion comprises a distal portion, an extension, and a proximal portion provided in the passage of fluid flow, and
wherein:
the distal portion is an inlet for a fluid,
the extension extends from the distal portion inward of the environmental sensor and has a cross-sectional area decreasing inward of the environmental sensor, and
the proximal portion is a distal end of the extension and is in communication with a nozzle assembly disposed in the environmental sensor.

8. The sensor barrier structure according to claim 1, further comprising: a nozzle assembly disposed in the environmental sensor,
wherein the nozzle assembly forms a portion of the passage of fluid flow from the intake portion to the sensing portion.

9. The sensor barrier structure according to claim 8, wherein the nozzle assembly comprises:
an inlet configured to communicate with the intake portion; and
a plurality of radial passages branching from the inlet, the radial passages each having a nozzle facing the sensing portion.

10. The sensor barrier structure according to claim 9, wherein the passage of fluid flow has a cross-sectional area gradually decreasing from the inlet to the nozzle.

11. The sensor barrier structure according to claim 1, wherein the environmental sensor further comprises a cap provided with the intake portion, the cap being mounted on an upper portion or a lower portion of the environmental sensor.

12. The sensor barrier structure according to claim 1, wherein the environmental sensor is a lidar sensor mounted on a roof of the vehicle.

13. An environmental sensor disposed on a vehicle and configured to sense a surrounding environment, the environmental sensor comprising:
a passage of fluid flow configured to receive a traveling wind of the vehicle to form a flow passage of the traveling wind,
wherein the passage of fluid flow receives the traveling wind to form an air curtain at the environmental sensor.

14. The environmental sensor according to claim 13, wherein the air curtain is formed at a portion of the environmental sensor facing a front of the vehicle.

15. The environmental sensor according to claim 13, wherein the passage of fluid flow is configured to direct the received traveling wind to a sensing portion of the environmental sensor.

16. The environmental sensor according to claim 13, wherein the passage of fluid flow is configured to allow the traveling wind to be introduced into an intake portion and sprayed through a nozzle and to have a cross-sectional area decreasing from the intake portion to the nozzle.
